(19) United States
(12) Patent Application Publication
(10) Pub. No.: US 2010/0209751 A1
(43) Pub. Date: Aug. 19, 2010

(54) BATTERY PACK AND ELECTRICAL DEVICE WITH THREE-DIMENSIONAL CODING MEANS

(76) Inventors: Wolf Matthias, Stuttgart (DE); Rainer Glauning, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/678,213

(22) PCT Filed: Jul. 28, 2008
(86) PCT No.: PCT/EP08/59867

§ 371 Date: Mar. 15, 2010

(30) Foreign Application Priority Data
Sep. 18, 2007 (DE) 10 2007 044 501.8

(51) Int. Cl. H01M 2/10

(52) U.S. Cl. 429/96

(57) ABSTRACT

The invention describes a battery pack for an electrical appliance, in particular for a handheld machine tool, having mechanical coding elements for interaction with corresponding coding elements on an electrical appliance. The coding elements are arranged in relation to one another with respect to a first axis in the insertion direction, a second axis transverse to the insertion direction, and a third axis transverse to the insertion direction and transverse to the second axis in such a way that they form a three-dimensional coding system.

### PRIOR ART

The invention relates to a battery pack for an electrical device and to an electrical device, in particular a handheld power tool, as defined generically by the preambles to independent claims 1 and 8.

There are numerous electric tools that are equipped with replaceable battery packs for supplying power to them. The battery packs are usually designed especially for a specific electric tool. Other battery packs, not intended for the electric tool, for instance with a different rated voltage, must not be used for the electric tool, so that the battery pack and/or the electric tool will not become damaged. To ensure the association of the proper battery pack with an electric tool, it is known to use mechanical coding systems, which allow the battery pack to be inserted and electrically contacted only whenever the battery pack has a code that corresponds with the counterpart code of the electric tool. In German Patent Disclosure DE 10 2005 008 036 A1, for instance, an insertable battery pack for an electric tool is described that has a mechanical coding system, and the code has at least one indentation cooperating on opposed sides with at least one protrusion forming the counterpart code on the tool.

Especially whenever a plurality of different battery packs for different electrical devices are available, when a battery pack is replaced it must reliably be prevented that the wrong battery pack be assigned to the electric tool. A secure and essentially tamperproof coding system is therefore necessary.

### DISCLOSURE OF THE INVENTION

The invention is based on a battery pack for an electrical device, in particular for a handheld power tool, which has means for mechanical coding for cooperation with corresponding coding means on an electrical device.

According to the invention, the coding means are disposed relative to one another, with respect to a first axis in the insertion direction, a second axis transverse to the insertion direction, and a third axis transverse to the insertion direction and transverse to the second axis, in such a way that they form a three-dimensional coding system, A three-dimensional coding system is understood to be a coding system whose coding means are operative in all three coordinate axes with respect to the insertion direction. The three-dimensional code results not only from the three-dimensional shape of the coding means but also from the spatial disposition of the coding means relative to one another. This makes an even greater number of combinations of coding means possible, even if the coding means have the same three-dimensional shape. The three-dimensional coding system according to the invention reliably makes it possible to prevent mistakes in manipulation, or in other words associating the wrong battery packs with an electrical device. The coding means and counterpart coding means must fit one another not only dimensionally but also in their spatial disposition. If a coding means does not correspond precisely with a counterpart coding means dimensionally and/or in its spatial disposition, then the battery pack and the electrical device cannot be connected to one another. It is thus ensured that only the correct battery packs are associated with an electrical device.

Within the scope of the present invention, the first axis is defined as the axis which extends parallel to the insertion direction. The second axis is formed by the axis that extends in a first direction transverse to the insertion direction, while the third axis is the axis which extends transversely both to the insertion direction and to the second axis. The spatial orientation of the three axes, which are at a right angle from one another, depends on the insertion direction of the battery pack. The battery pack may for instance be intended for being mounted on the lower free end of the handle of a handheld power tool, so as to form a base for the tool to stand on. In that case, the insertion direction is located in the horizontal direction, so that the first axis in the insertion direction, as well as the second axis transverse to the insertion direction, are horizontal axes, while the third axis transverse to the insertion direction is a vertical axis. However, there are also battery packs which for example are introduced into the handle in the vertical direction on the lower free end of the handle. In that case, the insertion direction is in the vertical direction. The second axis transverse to the insertion direction and the third axis transverse to the insertion direction are conversely horizontal axes. In principle, a battery pack can also be inserted at an arbitrary angle relative to a handheld power tool. In a further alternative, the battery pack can also be mounted on the handheld power tool by a pivoting motion. In such a battery pack, a three-dimensional coding system can also be used, and an insertion direction can be defined accordingly.

The coding means are preferably disposed in the vicinity of the interface between the battery pack and the electrical device. Electrical contact elements for the power supply and optionally further contact elements, for instance for data exchange, are present in the vicinity of the interface as well. A locking device, with which the battery pack can be connected detachably but securely to the electrical device, can also be disposed in the vicinity of the interface.

Coding along the first axis in the insertion direction is effected for instance by disposing two coding means offset from one another in the insertion direction. The coding means on a battery pack may for instance be coding ribs. The counterpart coding means on a handheld power tool are accordingly formed by corresponding coding ribs. For instance, if two coding ribs in the first axis are offset from one another, then the corresponding coding ribs along the first axis are embodied with different lengths. An offset of the coding means in the first axis can be combined for example with an offset in the second axis, so that the coding means are not aligned with one another in the insertion direction, but are offset both longitudinally of one another and laterally.

Coding along the second axis transverse to the insertion direction is effected for instance by disposing two coding means offset from one another transverse to the insertion direction. In addition, the coding means offset from one another transversely to the insertion direction in the second axis may be identical or different. For instance, they can have a different length along the second axis. Thus the coding means may for instance be coding ribs, which are of the same length or different lengths along the second axis. The counterpart coding means must accordingly have corresponding coding ribs of identical or different lengths along the third axis.

Coding along the third axis transverse to the insertion direction and transverse to the second axis is effected for instance by disposing two coding means offset from one another in the third axis. This can be done for instance by providing that the coding means in the third axis have a different length. In a battery pack with a horizontal insertion direction, the third axis is oriented vertically, so that the coding means have a different vertical length.

Alternatively, the coding means in the third axis may be offset from one another, in that the coding means are disposed in at least two different coding planes. A coding plane is defined by two of the three axes. For instance, in a battery pack with a horizontal insertion direction, the first and second axes define a horizontal coding plane. In the coding plane, the coding means are disposed such that they form a three-dimensional coding system. To enable disposing the coding means offset from one another in the third axis as well, two or more parallel coding planes are preferably provided. In a battery pack with a horizontal insertion direction, two horizontal, parallel coding planes can be disposed longitudinally of one another with a vertical offset, for instance in the insertion direction. The two horizontal, parallel coding planes can also be disposed such that they are offset laterally and vertically transversely to the insertion direction. Analogously, in a battery pack with a vertical insertion direction, two vertical, parallel coding planes can be provided longitudinally of one another in the insertion direction or laterally and with a horizontal offset. It is moreover possible to provide more than two coding planes, which can be offset from one another longitudinally and/or laterally in the insertion direction. A three-dimensional coding system with two or more coding planes considerably increases the number of possible combinations of coding means. Combining a battery pack with an electrical device for which the battery pack is not intended can thus be prevented all the more securely. In particular, coding planes that are parallel to one another but offset from one another have the advantage that the three-dimensional coding system can be accommodated in the smallest possible space yet with a great many possible coding options.

Instead of two or more parallel coding planes, two or more coding planes can be at a right angle to one another. For instance, in a battery pack with a horizontal insertion direction, one horizontal and one vertical coding plane may be provided, and the horizontal coding plane is defined by the first and second axes, while the vertical coding plane is defined by the first and third axes. The coding planes disposed perpendicular to one another can thus be equipped with coding means in such a way that a three-dimensional coding system is formed. Coding planes disposed perpendicular to one another can be used for instance in battery packs with a vertical insertion direction, since then as a rule, despite the compactness of the battery packs and of the electrical devices, there is more space available for the coding means in the vicinity of the interface.

The three-dimensional coding system includes at least two coding means. If there are only two coding means, then they are offset from one another with respect to the first axis, second axis, and third axis, in order to form a three-dimensional coding system. These two coding means may for instance be coding ribs, which are offset from one another in the first and second axes and as a result are offset from one another in the third axis because they have a different length along the third axis. The two coding means may, however, also have the same length along the third axis but be disposed in different coding planes.

If the three-dimensional coding system includes at least three coding means, then two coding means may also be offset from one another with respect to only two of the three axes, if the three coding means overall are offset from one another in all three planes; that is, all combinations of two coding means at a time must result in an offset of the coding means in all three axes.

The more coding means are used, the higher is the number of possible combinations of coding means. Combining a battery pack with an electrical device that is not suitable for the electrical device can thus be effectively prevented. The more complex the three-dimensional coding system is, the less is the risk that the coding system can be tampered with by improper handling, for instance by removing or bypassing coding ribs.

The coding means on the counterpart coding means themselves have a three-dimensional shape. The coding means are in particular coding ribs. The counterpart coding means are accordingly formed by corresponding coding ribs. The coding ribs can also have rounded edges or corners, or instead of a polygonal cross section, they may generally have a round or other kind of cross section. The coding ribs may be provided on the battery pack, while a battery-operated electrical device has corresponding coding ribs as its counterpart coding means. On the other hand, naturally the electrical device, in particular the handheld power tool, may be provided with coding ribs that cooperate with corresponding coding ribs on a battery pack.

A battery-operated electrical device, in particular a handheld power tool, forms a further subject of the invention. The electrical device is suitable for being connected to the battery pack of the invention. To that end, the electrical device has means for mechanical coding which form a coding system that is compatible with the coding system of the battery pack of the invention. The coding means of the electrical device are disposed relative to one another with respect to a first axis in the insertion direction, a second axis transverse to the insertion direction, and a third axis transverse to the insertion direction, such that they form a three-dimensional coding system.

The invention is described in further detail below in conjunction with the accompanying drawings.

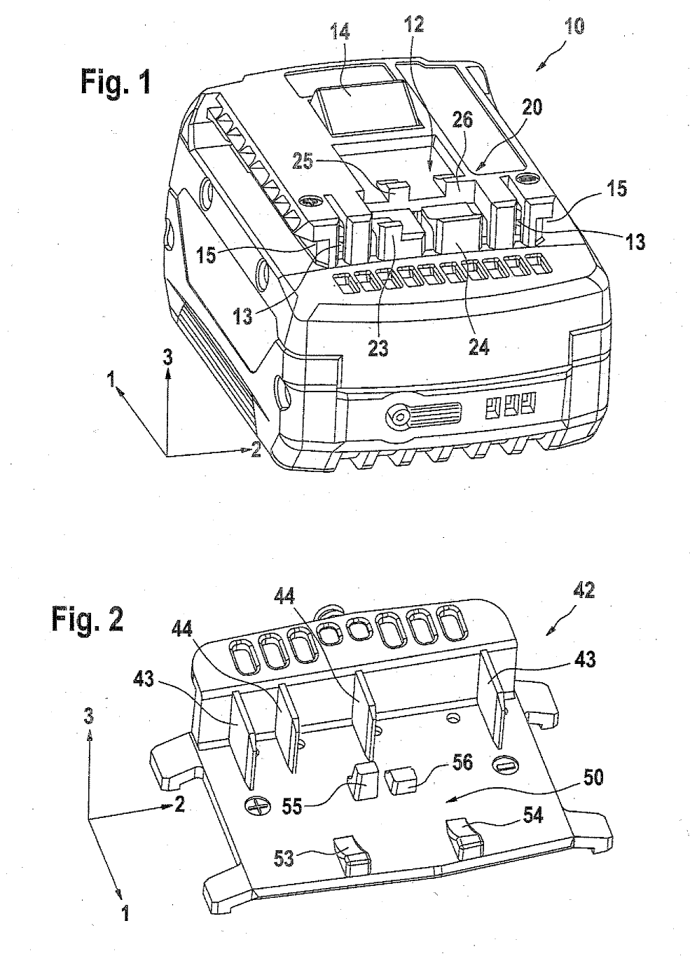

FIG. 1 shows a battery pack of the invention, with a first embodiment of a three-dimensional coding system, in a perspective view;

FIG. 2 shows an interface of a handheld power tool with a coding system corresponding to the battery pack of FIG. 1;

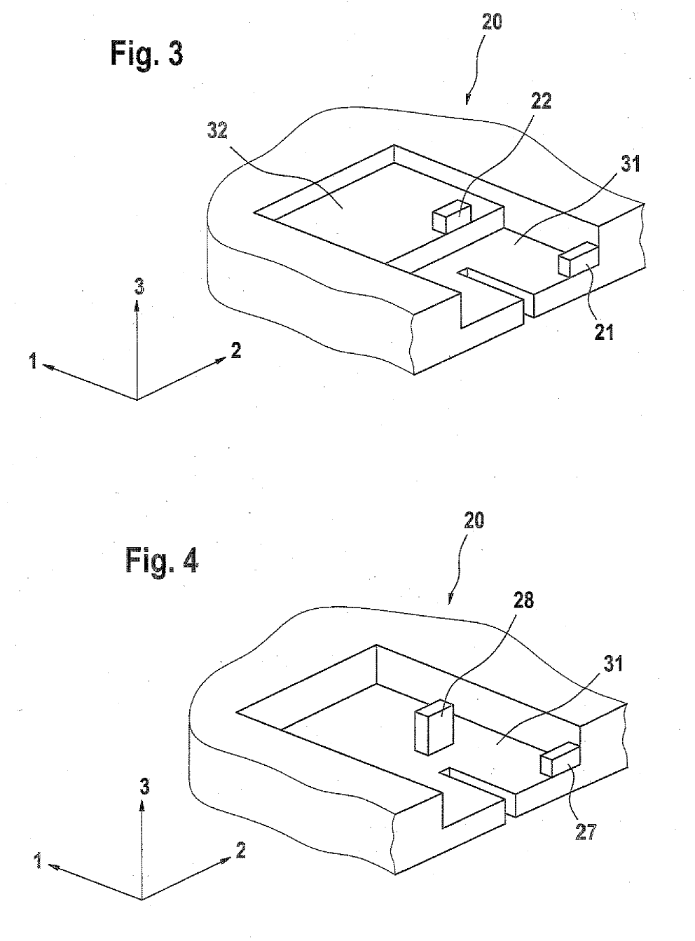

FIG. 3 shows a second embodiment of a three-dimensional coding system in a schematic view;

FIG. 4 shows a third embodiment of a three-dimensional coding system in a schematic view;

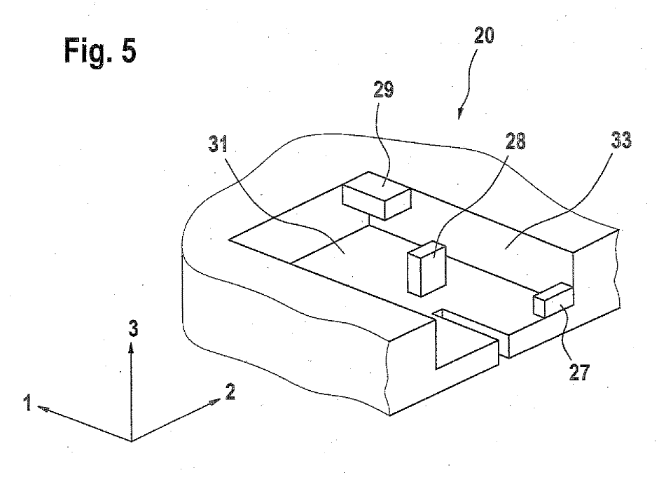

FIG. 5 shows a fourth embodiment of a three-dimensional coding system in a schematic view.

FIG. 1 shows a replaceable battery pack 10, which is suitable particularly for a handheld power tool (not shown), such as a drill or screwdriver. To enable effectively preventing the battery pack 10 from being associated with a handheld power tool for which the battery pack 10 is not permitted, means 23, 24, 25, 26 for mechanical coding are provided on the battery pack 10. The mechanical coding means 23, 24, 25, 26, upon attachment of the battery pack 10 to a handheld power tool, cooperate with corresponding coding means (not shown), so that only when the coding means correspond to one another can the battery pack 10 be attached to the handheld power tool. According to the invention, the coding means 23, 24, 25, 26 form a three-dimensional coding system 20.

The three-dimensional coding system 20 is disposed in the vicinity of the interface 12 between the battery pack 10 and the handheld power tool. Electrical contact elements 13 for the power supply are also present in the vicinity of the interface 12. A locking device 14 with a bolt, with which the battery pack 10 can be connected detachably but securely to a handheld power tool, is also disposed in the vicinity of the interface 12. The battery pack 10 is moreover equipped with guide means 15, in the form of guide grooves. The guide means 15 facilitate the correct introduction of the battery pack 10 into the battery pack receptacle of a handheld power tool. As can be seen from FIG. 1, the guide means 15 are disposed in the horizontal direction. Accordingly, the insertion direction is horizontal. It is indicated in FIG. 1 by arrow 1 and simultaneously forms the first axis 1. The battery pack 10 is secured to a free lower end of a handle of a handheld power tool and forms a base for the tool to stand on.

The coding means 23, 24, 25, 26, in the embodiment shown in FIG. 1, take the form of coding ribs. The counterpart coding means 53, 54, 55, 56 (FIG. 2) are accordingly formed by corresponding coding ribs. As can be seen from FIG. 1, the coding ribs may also have rounded edges or corners.

The coding means 23, 24, 25, 26 are disposed relative to one another, with respect to a first axis 1, which extends parallel to the insertion direction, a second axis 2, which extends in a first direction transverse to the insertion direction, and a third axis 3, which extends in a second direction transverse to the insertion direction and transverse to the second axis 2, in such a manner that they form a three-dimensional coding system 20. In FIGS. 1 through 5, the axes 1, 2, 3 are indicated by arrows. In the embodiments shown in FIGS. 1 through 5, the first and second axes 1, 2 are in the horizontal direction, while the third axis 3 is oriented vertically. The coding means 23, 24, 25, 26 form a three-dimensional coding system 20, in that the coding means 21, in that the coding means 21 are operative in all three coordinate axes 1, 2, 3. The three-dimensional code [or “code”—called coding system elsewhere] 20 is thus due above all to the spatial disposition of the coding means 23, 24, 25, 26 relative to one another. In addition, the coding means 23, 24, 25, 26 can increase the number of coding possibilities, because of their three-dimensional shape.

The three-dimensional coding system 20 of FIG. 1 includes four coding means 23, 24, 25, 26, which are disposed on two parallel, but vertically offset coding planes 31, 32. The coding planes 31, 32 are defined by the first and second axes 1, 2, respectively. They make it possible to provide a three-dimensional coding system 20 with a high number of coding possibilities while requiring comparatively little space. The coding means 23, 25 and 23, 26 are offset from one another in all three axes 1, 2, 3. The coding means 24, 25 and 24, 26 are likewise offset from one another in all three axes 1, 2, 3, and a further factor is that the coding means 24 is wider than the coding means 25, 26; that is, its length along the second axis 2 is greater. The pairs of coding means 23, 24 and 25, 26 are each offset from one another in only one of the three axes, namely the second axis 2. The battery pack of FIG. 1 can be combined with a handheld power tool only if the latter has a coding system 50 corresponding to the three-dimensional coding system 20.

An interface 42 of a handheld power tool, corresponding to the interface 12 of the battery pack 10, is shown in perspective in FIG. 2. The interface 42 is provided with two electrical contact elements 43, which make contact with the contact elements 13 when the battery pack 10 is attached to the handheld power tool. Two data contact elements 44 are also provided. The interface 42 is provided with four coding means 53, 54, 55, 56 in the form of coding ribs, which form a three-dimensional coding system 50 that is embodied correspondingly to the coding system 20, so that the battery pack 10 can be connected to the interface 42 of the handheld power tool. The coding means 53, 54, 55, 56 are disposed such that they slide past the coding means 23, 24, 25, 26 when the battery pack is attached to the handheld power tool in the insertion direction with the aid of the guide means 15. For instance, the coding means 53 slides beyond the coding means 23 and past the coding means 25, while the coding means 54 slides beyond the coding means 24 and past the coding means 26. The coding means 55 slides past the coding means 23, and the coding means 56 slides beyond the coding means 24.

FIG. 3 shows a simple exemplary embodiment of an alternative three-dimensional coding system 20 with two coding means 21, 22. In order to form a three-dimensional coding system 20, the two coding means 21, 22 are offset from one another both with respect to the first axis 1 and with respect to the second axis 2 and the third axis 3. It can clearly be seen from FIG. 2 that the coding means 21, 22 are disposed longitudinally of one another in the insertion direction, that is, along the first axis 1. They are furthermore offset from one another laterally, that is, along the second axis 2. Finally, the coding means are offset from one another vertically, that is, along the third axis 3, because they are each disposed on one of two vertically offset parallel coding planes 31, 32. The coding planes 31, 32 in FIG. 2 are defined by the first and second axes 1, 2. The two coding planes 31, 32 allow the provision of a three-dimensional coding system 20, which offers a high number of coding possibilities while requiring comparatively little space.

FIG. 4 shows a third embodiment of a three-dimensional coding system 20. Similarly to the coding system of FIG. 2, it includes two coding means 27, 28. To form a three-dimensional coding system 20, the two coding means 27, 28 are offset from one another both with respect to the first axis 1 and with respect to the second axis 2 and the third axis 3. Unlike FIG. 2, however, the two coding means 27, 28, although they are disposed in only one coding plane 31, are nevertheless offset from one another in the third axis 3 because they have a different length along the third axis 3. The coding means 28 is higher than the coding means 21.

In FIG. 5, a further embodiment of a three-dimensional coding system 20 is shown schematically; once again it has two coding planes 31, 33. In a distinction from the embodiments shown in FIGS. 1 and 2, the coding planes 31, 33 are perpendicular to one another. The coding plane 31 is defined by the axes 1, 2 and the coding plane 33 is defined by the axes 1, 3. Analogously to the embodiment shown in FIG. 3, the coding system includes the coding means 27, 28, and it additionally includes a coding means 29, which is disposed offset from the coding means 27 in the first and third axes 1, 3 and from the coding means 28 in all three axes 1, 2, 3. Two coding planes 31, 33 perpendicular to one another likewise make it possible to establish a three-dimensional coding system 20, because the coding means 27, 28, 29 are offset from one another in all three axes 1, 2, 3.

1-8. (canceled)

9. A battery pack for an electrical device, in particular for a handheld power tool, the battery pack having mechanical coding means for cooperation with corresponding coding means on the electrical device upon attachment of the battery pack to the device in an insertion direction, the coding means on the battery pack being disposed relative to one another, with respect to a first axis in an insertion direction, a second axis transverse to the insertion direction, and a third axis transverse to the insertion direction and transverse to the second axis, in such a way that the coding means form a three-dimensional coding system.

10. The battery pack as defined by claim 9, wherein at least two coding means are present, which are offset from one another with respect to the first axis, the second axis, and the third axis.

11. The battery pack as defined by claim 9, wherein at least three coding means are present, and two coding means at a time are disposed offset from one another relative to at least two of the first axis, the second axis, and the third axis.

12. The battery pack as defined by claim 10, wherein at least three coding means are present, and two coding means at a time are disposed offset from one another relative to at least two of the first axis, the second axis, and the third axis.

13. The battery pack as defined by claim 9, wherein the coding means are disposed offset from one another in the third axis in that the coding means have a different length in a direction of the third axis.

14. The battery pack as defined by claim 10, wherein the coding means are disposed offset from one another in the third axis in that the coding means have a different length in a direction of the third axis.

15. The battery pack as defined by claim 11, wherein the coding means are disposed offset from one another in the third axis in that the coding means have a different length in a direction of the third axis.

16. The battery pack as defined by claim 12, wherein the coding means are disposed offset from one another in the third axis in that the coding means have a different length in a direction of the third axis.

17. The battery pack as defined by claim 9, wherein the coding means are disposed offset from one another in the third axis in that the coding means are disposed in at least two different coding planes.

18. The battery pack as defined by claim 10, wherein the coding means are disposed offset from one another in the third axis in that the coding means are disposed in at least two different coding planes.

19. The battery pack as defined by claim 11, wherein the coding means are disposed offset from one another in the third axis in that the coding means are disposed in at least two different coding planes.

20. The battery pack is defined by claim 13, wherein the coding means are disposed offset from one another in the third axis in that the coding means are disposed in at least two different coding planes.

21. The battery pack as defined by claim 16, wherein the coding means are disposed offset from one another in the third axis in that the coding means are disposed in at least two different coding planes.

22. The battery pack as defined by claim 9, wherein the coding means are disposed offset from one another in the second axis in that the coding means have a different length in a direction of the second axis.

23. The battery pack as defined by claim 10, wherein the coding means are disposed offset from one another in the second axis in that the coding means have a different length in a direction of the second axis.

24. The battery pack as defined by claim 21, wherein the coding means are disposed offset from one another in the second axis in that the coding means have a different length in a direction of the second axis.

25. The battery pack as defined by claim 9, wherein the coding means are coding ribs.

26. The battery pack as defined by claim 10, wherein the coding means are coding ribs.

27. The battery pack as defined by claim 24, wherein the coding means are coding ribs.

28. A battery-operated electrical device, in particular a handheld power tool, the device having mechanical coding means for cooperation with corresponding coding means on a battery pack upon attachment of the device to the battery pack in an insertion direction, the coding means on the device being disposed relative to one another with respect to a first axis in the insertion direction, a second axis transverse to the insertion direction, and a third axis transverse to the insertion direction and transverse to the second axis, in such a manner that the coding means form a three-dimensional coding system.
